(19) United States
(12) Patent Application Publication
(10) Pub. No.: US 2026/0082419 A1
(43) Pub. Date: Mar. 19, 2026

(54) METHOD AND ACCESS POINT FOR SHARING TXOP

(71) Applicant: TP-Link Systems Inc., IRVINE, CA (US)

(72) Inventors: Renfang ZHOU, Shenzhen (CN); Junbin CHEN, Chengdu (CN)

(73) Assignee: TP-Link Systems Inc., IRVINE, CA (US)

(21) Appl. No.: 18/887,162

(22) Filed: Sep. 17, 2024

(51) Int. Cl. H04W 74/0808; H04W 88/08

(52) U.S. Cl. CPC H04W 74/0808; H04W 88/08

(57) ABSTRACT

The present disclosure provides a method and an AP for sharing a transmission opportunity (TXOP). A sharing access point (AP) according to the embodiment of the present disclosure includes a transmitter configured to transmit a first trigger frame for announcing a transmission opportunity (TXOP) to be shared; a receiver configured to receive responses from a plurality of candidate shared APs, wherein each response corresponds to one of the plurality of candidate shared APs, and includes information on interferential APs of the one of the plurality of candidate shared APs; a processor configured to determine one or more shared APs from the plurality of candidate shared APs based on the responses; and the transmitter further configured to transmit a second trigger frame which includes identity (ID) information of the one or more shared APs.

### TECHNICAL FIELD

The present disclosure relates to wireless communication, and more specifically, to a method for sharing TXOP and an access point (AP) performing the method.

### BACKGROUND

In current wireless communication systems, the demand for low network latency is getting higher. In the draft of Wi-Fi 7, the transmit opportunity (TXOP) Sharing (TXS) is formally adopted as a technique for the MAC layer. This technique allows an APs to share its TXOP to a station (STA). With the shared TXOP, the STA can continuously transmit multiple UL frames to the AP, or initiate P2P transmissions to other STAs.

It is proposed that an AP can share its TXOP with other AP(s). For example, the contention time-division multiple access (C-TDMA), which is an important expansion point for Multi-AP, intends to share the TXOP of the current AP with other AP(s), so that the resources can be used more effectively.

### SUMMARY

In view of the above, the present disclosure an access point (AP) and a method of wireless communication of an AP.

According to an aspect of the present disclosure, there is a sharing access point (AP) for sharing the transmission opportunity (TXOP). The sharing AP comprises: a transmitter configured to transmit a first trigger frame for announcing a transmission opportunity (TXOP) to be shared; a receiver configured to receive responses from a plurality of candidate shared APs, wherein each response corresponds to one of the plurality of candidate shared APs, and includes information on interferential APs of the one of the plurality of candidate shared APs; and a processor configured to determine one or more shared APs from the plurality of candidate shared APs based on the responses, wherein the transmitter is further configured to transmit a second trigger frame which includes identity (ID) information of the one or more shared APs.

In some embodiments, the information on interferential APs of the one of the plurality of candidate shared APs includes a neighbour list, which includes ID information of APs sensed by the one of the plurality of candidate shared AP; and the determining one or more shared APs from the plurality of candidate shared APs based on the responses comprises: determining one or more shared APs based on neighbour lists of the plurality of candidate shared APs such that ID information of none of the shared APs is included in neighbour lists of other shared APs.

In some embodiments, the ID information of APs sensed by the one of the plurality of candidate shared APs includes BSSID information of APs sensed by the one of the plurality of candidate shared AP.

In some embodiments, the ID information of the one or more shared APs includes BSSID information of the one or more shared APs.

In some embodiments, each response corresponding to one of the plurality of candidate shared APs further includes BSS color information of the one of the plurality of candidate shared AP; and the ID information of the one or more shared APs further includes BSS color information of the shared APs.

In some embodiments, the information on interferential APs of the one of the plurality of candidate shared APs includes a BSS color list which includes BSS color information of APs sensed by one or more stations (STAs) connected with the one of the plurality of candidate shared APs and BSS color information of APs sensed by the one of the plurality of candidate shared APs; each response corresponding to one of the plurality of candidate shared APs further includes BSS color information of the one of the plurality of candidate shared AP; and the determining one or more shared APs from the plurality of candidate shared APs based on the responses: determining one or more shared APs based on the BSS color information of the plurality of candidate shared APs and BSS color lists of the plurality of candidate shared APs such that BSS color information of none of the shared APs is included in BSS color lists of other shared APs.

In some embodiments, when more than one shared APs are determined, the more than one shared APs will share the same frequency and time resources of the TXOP.

According to an aspect of the present disclosure, there is a shared access point (AP). The candidate shared AP comprises: a receiver configured to receive a first trigger frame for announcing a transmission opportunity (TXOP) to be shared; and a transmitter configured to transmit a response to the first trigger frame, wherein the response includes information on interferential APs of the shared AP, wherein the receiver is further configured to receive a second trigger frame which includes identity (ID) information of the shared AP.

In some embodiments, the information on interferential APs of the shared AP includes a neighbour list, which includes ID information of neighbour APs sensed by the shared AP.

In some embodiments, the response further includes BSS color information of the shared AP.

In some embodiments, the second trigger frame further includes ID information of the shared AP and at least one other shared AP; and the shared AP further comprises: a processor configured to determine a communicating STA to be communicated with in the TXOP from connected STAs connected with the shared AP based on the ID information of the at least one other shared AP and ID information lists of APs sensed by the connected STAs and BSS color information of APs sensed by the shared AP, wherein the ID information of the at least one other shared AP is not included in the ID information list of APs sensed by the communicating STA and the present the shared AP.

In some embodiments, the ID information of shared AP and at least one other shared APs includes: BSSID information of the shared AP and at least one other shared APs; BSS color information of the shared AP and at least one other shared APs; or the combination thereof.

In some embodiments, the ID information lists of APs sensed by each of the connected STAs includes: BSSID information of APs sensed by each of the connected STAs; BSS color information of APs sensed by each of the connected STAs; or the combination thereof.

In some embodiments, the information on interferential APs of the candidate shared AP includes a BSS color list, which includes BSS color information of APs sensed by connected STAs connected with the shared AP and BSS color information of APs sensed by the shared APs.

According to another aspect of the present disclosure, there is provided a method for wireless communication at a sharing access point (AP). The method comprises: transmitting a first trigger frame for announcing a transmission opportunity (TXOP) to be shared; receiving responses from a plurality of candidate shared APs, wherein each response corresponds to one of the plurality of candidate shared APs, and includes information on interferential APs of the one of the plurality of candidate shared APs; determining one or more shared APs from the plurality of candidate shared APs based on the responses; and transmitting a second trigger frame includes information related to identity (ID) s of the one or more shared APs.

In some embodiments, the information of on interferential APs of the one of the plurality of candidate shared APs includes a neighbour list, which includes ID information of APs sensed by the one of the plurality of candidate shared AP; and the determining one or more shared APs from the plurality of candidate shared APs based on the responses comprises: determining one or more shared APs based on neighbour lists of the plurality of candidate shared APs such that ID information of none of the shared APs is included in neighbour lists of other shared APs.

In some embodiments, the ID information of APs sensed by the one of the plurality of candidate shared APs includes BSSID information of APs sensed by the one of the plurality of candidate shared AP.

In some embodiments, the ID information the one or more shared APs includes the BSSID information of the one or more shared APs.

In some embodiments, the method further comprises: determining BSS color information of the candidate shared APs from the responses; wherein the ID information of the one or more shared APs further includes BSS color information of the shared APs.

In some embodiments, the information on interferential APs of the one of the plurality of candidate shared APs includes a BSS color list which includes BSS color information of APs sensed by one or more STAs connected with the one of the plurality of candidate shared APs and BSS color information of APs sensed by the one of the plurality of candidate shared APs; the method further comprises: determining BSS color information of the candidate shared APs from the responses, the determining one or more shared APs from the plurality of candidate shared APs based on the responses: determining one or more shared APs based on the BSS color information of the plurality of candidate shared APs and BSS color lists of the plurality of candidate shared APs such that BSS color information of none of the shared APs is included in BSS color lists of other shared APs.

At least based on the above embodiments of the present disclosure, an improved mechanism for using the resources of the shared TXOP. The present disclosure is to leverage the characteristic of the APs which are hidden to each other, to determine one or more shared APs. Thus, the resources of the shared TXOP can be used more effectively.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements. In the accompanying drawings.

FIG. 1 is a diagram illustrating an example of sharing AP and candidate shared APs in a wireless network, in accordance with the present disclosure;

FIG. 2 is a diagram illustrating an example of the procedure for sharing the TXOP from a sharing AP to two shared APs, in accordance with the present disclosure;

FIG. 3 is a diagram illustrating an example of the procedure for sharing the TXOP from a sharing AP to four shared APs, in accordance with the present disclosure;

FIG. 4 shows a flowchart illustrating a method for wireless communication at a sharing AP in accordance with one or more aspects of the present disclosure;

FIG. 5 shows a flowchart illustrating a method for wireless communication at a candidate shared AP in accordance with one or more aspects of the present disclosure.

FIG. 6 is a schematic block diagram of a sharing AP according to one embodiment of the present disclosure.

FIG. 7 is a schematic block diagram of a candidate shared AP according to one embodiment of the present disclosure.

FIG. 8 shows a schematic block diagram of AP in accordance with one or more aspects of the present disclosure.

### DETAILED DESCRIPTION

The technical solution of the present disclosure will be clearly and completely described below in conjunction with accompanying drawings. The described embodiments are part of embodiments of the present disclosure, but not all of them. Based on the embodiments in the present disclosure, all other embodiments acquired by ordinary skilled in the art without making any creative efforts fall within the scope of protection of the present disclosure.

Some of the drawings may not depict all the components of a given method, device and system. Like reference numerals may be used to denote like features throughout the specification and drawings.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined with each other as long as no conflicts occurs therebetween.

In the present disclosure, an AP, which may be interchangeably referred to as a wireless access point (WAP), is a communication device that can communicate with a non-AP (e.g., a station (STA) or client device) in a WLAN and that allows the non-AP to connect to a wired network. The AP usually connects to a router (via a wired network) as a standalone device, but it can also be integrated with or employed in the router.

Likewise, in the present disclosure, a non-AP (e.g., a client device or station, which is interchangeably referred to as a STA) is a communication device that can communicate with an AP to obtain various communication services such as voice, video, packet data, messaging, broadcast, etc. The STA can be any device that contains an IEEE 802.11-conformant media access control (MAC) and physical layer (PHY) interface to the wireless medium (WM). For example, a STA may be a laptop, a desktop personal computer (PC), a personal digital assistant (PDA), an access point or a Wi-Fi phone in a WLAN environment. The STA may be fixed or mobile. In the WLAN environment, the terms “STA”, “client device”, “wireless client”, “user” and “user device” are often used interchangeably.

In the present disclosure, a STA in a WLAN may work as an AP at a different occasion, and vice versa. This is because communication devices in the context of IEEE 802.11 (Wi-Fi) technologies may include both STA hardware components and AP hardware components. In this manner, the communication devices may switch between a STA mode and an AP mode, based on actual WLAN conditions and/or requirements. In various embodiments below, a non-AP STA may refer to a STA in a WLAN that is not implemented as an AP.

As previously mentioned, in the draft of Wi-Fi 7, the TXS is formally adopted as a technique for the MAC layer. Recently, it is proposed that an AP can share its TXOP with other AP(s). However, when allocating the TXOP with other AP(s), the sharing AP does not consider the APs which are hidden to each other.

In view of at least the above problem, the overall concept of the present disclosure is to leverage the characteristic of the APs which are hidden to each other, to determine one or more shared APs. Thus, the resources of the shared TXOP can be used more effectively. For example, the same frequency and time resources in the shared TXOP can be allocated to two or more APs which are hidden to each other. An AP (a first AP) which is not hidden to another AP (a second AP) is referred to an interferential AP of the second AP, that is, the first AP can be sensed by the second AP. On the other hand, the APs which are hidden to each other may refer to the APs which are not the interferential AP to each other. For example, among the APs which are hidden to each other, there is no interference, or the interference is lower than a certain threshold. In the embodiments of the present disclosure, the AP may scan the signal from the other APs to sense the other APs.

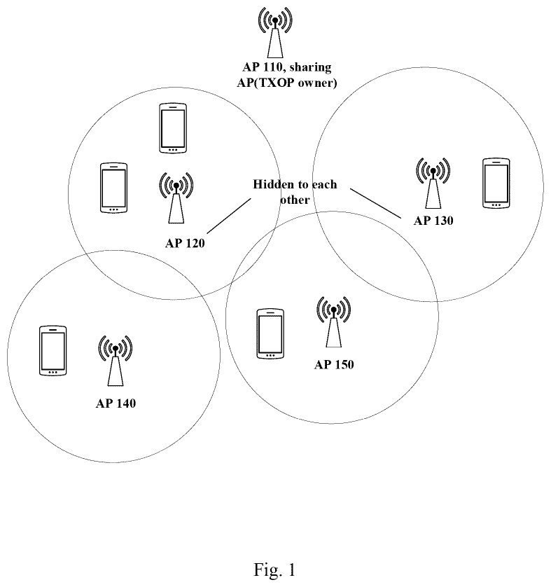

FIG. 1 is a diagram illustrating an example of a sharing AP and candidate shared APs in a wireless network, in accordance with the present disclosure. As shown in FIG. 1, the AP 110 is the sharing AP, which is the owner of the TXOP to be shared. AP 120, AP 130, AP 140 and AP 150 are candidate shared APs which may use the TXOP of AP 110.

In the example of FIG. 1, the AP 120 and the AP 130 are two APs which are hidden to each other. For one example, the AP 120 cannot sense the signals sent from the AP 130. For another example, the AP 120 can sense the signals sent from the AP 130, but the strength of sensed signals sent from the AP 130 is lower than a specific threshold. Moreover, the AP 130 cannot sense the signals sent from the AP 120, either, or the AP 130 can sense the signals sent from the AP 120, but the strength of sensed signals sent from the AP 120 is lower than a specific threshold. On the other hand, the AP 120 can sense the signals sent from the AP 140, and the signals sent from the AP 140 may cause the interference to the transmission of the AP 120, vice versa. Moreover, the AP 130 can sense the signals sent from the AP 150, and the signals sent from the AP 150 may cause the interference to the transmission of the AP 130, vice versa.

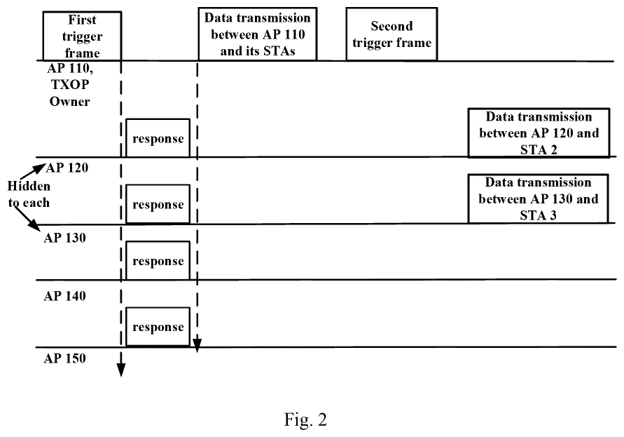

FIG. 2 is a diagram illustrating an example of the procedure for sharing the TXOP from a sharing AP to two shared APs, in accordance with the present disclosure. In the following, the procedure for sharing the TXOP shown in FIG. 2 will be described by taking the sharing AP and candidate shared APs shown in FIG. 1 as an example.

As shown in the FIG. 2, the AP 110 transmits a first trigger frame for announcing that the AP 110 has a TXOP to be shared. The AP 120, AP 130, AP 140 and AP 150 receive the first trigger frame. Moreover, each of the AP 120, AP 130, AP 140 and AP 150 transmits a response to the first trigger frame, wherein the response includes information on interferential APs of the corresponding AP. As mentioned above, the interferential APs of the corresponding AP may refer to the APs which are not hidden to the corresponding AP. For example, the interferential APs may refer to the APs which may have interference to the corresponding AP, or the interference from which to the corresponding AP is higher than a certain threshold.

In the example of FIG. 2, after receiving the responses from the AP 120, AP 130, AP 140 and AP 150, and the AP 110 determines one or more shared APs from the plurality of candidate shared APs based on the responses. Specifically, according to the information on interferential APs in the responses, the AP 110 determines the APs which are hidden to each other as the shared APs. For example, the AP 110 may determine the AP 120 and AP 130 as the shared APs which will share the same frequency and time resources in the shared TXOP. And the AP 110 transmits a second trigger frame which includes identity (ID) information of the shared APs. And then, the AP 120 can perform the data transmission to the STAs connected to the AP 120 by using the shared TXOP, and the AP 130 can perform the data transmission to the STAs connected to the AP 130 by using the same frequency and time resources in the shared TXOP. By assigning the same frequency and time resources in the shared TXOP to two or more APs which are hidden to each other, the efficiency of using the resources of the shared TXOP can be further improved.

On the other hand, if there is no two or more APs which are hidden to each other according to the information on interferential APs in the responses, the AP 110 may determine one candidate shared AP from the AP 120, AP 130, AP 140 and AP 150 as the shared AP. In this case, the second trigger frame transmitted by the AP 110 will includes identity (ID) information of the one shared AP.

In one example of the present disclosure, the information on interferential APs of the one of the plurality of candidate shared APs in the response to the first trigger frame may include a neighbour list of the one of the plurality of candidate shared APs. The neighbour list includes the ID information of the APs sensed by the one of the plurality of candidate shared AP. For example, the ID information of APs sensed by the one of the plurality of candidate shared APs may include the BSSID information or other ID information of the APs sensed by the one of the plurality of candidate shared AP. For example, the one of the plurality of candidate shared AP may scan the signals from other APs to obtain its neighbour list.

The sharing AP can determine one or more shared APs based on neighbour lists of the plurality of candidate shared APs such that ID information of none of the shared APs is included in neighbor lists of other shared APs. For another example, the candidate shared AP may scan the signal from the other APs to obtain the BSSID information or other ID information of the interferential APs.

For example, with respect to the candidate shared APs 120-150, the neighbour list of AP 120 may include the BSSID information of AP 140 and AP 150, the neighbour list of AP 130 may include the BSSID information of AP 150, the neighbour list of AP 140 may include the BSSID information of AP 120, and the neighbour list of AP 150 may include the BSSID information of AP 120 and AP 130. The sharing AP 110 may determine the shared APs based on neighbour lists in the responses from the candidate shared APs 120-150. It can be seen that the AP 120 and the AP 130 are not included in the neighbour lists of AP 120 and AP 130. Thus, the sharing AP 110 may determine the AP 120 and the AP 130 as the shared AP. On the other hand, the sharing AP 110 does not determine the AP 140 or the AP 150 as the shared AP, since the AP 140 or the AP 150 are included in the neighbour list of 120.

Although the determined plurality of shared APs are hidden to each other, if one STA can receive the signals sent by the plurality of shared APs, the communication of the STA with one shared AP may be disturbed by the transmission from other shared AP(s). Additionally, according to one example of the present disclosure, the shared APs may determine the communicating STA to be communicated with based on the second trigger frame and an ID information list of APs sensed by the connected STA. Specifically, after receiving a second trigger frame which includes the ID information of more than one shared APs, a shared AP may determine a communicating STA to be communicated with by the frequency and time resources of the TXOP, based on the ID information related of shared APs included in the second trigger frame and an ID information list of APs sensed by the connected STA. For example, the shared AP may perform the data transmission with the STA which cannot receive the signals sent by the plurality of shared APs by using the shared TXOP. For example, ID information list of APs sensed by the connected STA, which is determined by the shared AP to be communicated with, does not include the ID information of the other shared AP(s).

Taking the shared APs shown in FIG. 2 as an example. As mentioned above, the sharing AP 110 may determine the AP 120 and the AP 130 as the shared AP. Assuming there are STA 1 and STA 2 are connected with AP 120, STA 3 is connected with AP 130, the ID information list of APs sensed by the STA 1 (which is not illustrated) includes the ID information of AP 130, the ID information list of APs sensed by the STA 2 does not include the ID information of AP 130, and the ID information list of APs sensed by the STA 3 does not include the ID information of AP 120. Thus, based on the ID information related of shared APs included in the second trigger frame and an ID information list of APs sensed by the STA, the AP 120 may determine the STA 2 to be communicated with by the frequency and time resources of the TXOP, and the AP 130 may determine the STA 3 to be communicated with by the frequency and time resources of the TXOP.

In one example of the present disclosure, the response to the first trigger frame includes the ID information of the corresponding candidate shared APs. For example, the response to the first trigger frame may include the BSSID information of the candidate shared AP, BSS color information of the candidate shared AP or the combination thereof. Accordingly, the ID information of the one or more shared APs in the second trigger frame may include BSSID information of one or more shared APs, BSS color information of one or more shared APs, or the combination thereof. Moreover, the ID information list of APs sensed by the STA may include BSSID information of APs sensed by the STA, BSS color information of APs sensed by the STA, or the combination thereof.

In the above example, the shared AP determines the STA to be communicated with based on the second trigger frame and an ID information list of APs sensed by the STA, to avoid the interference from the other shared AP(s). In another example of the present disclosure, the ID information list of APs sensed by the STAs connected with the candidate shared AP and the ID information list of APs sensed by the candidate shared AP may be included in the response to the first trigger frame. Thus, the sharing AP can further consider the APs sensed by the STAs connected with a certain candidate shared AP when determine the shared AP(s). In this case, the shared AP does not need to select the STA to communicate with.

For example, the ID information on none of the determined plurality of shared APs is included in ID information list of APs sensed by the STAs connected with other shared AP(s). In another word, the sharing AP can consider the APs sensed by the STAs connected with the candidate shared APs based on the ID information lists of APs sensed by the STAs connected with the candidate shared APs. Thus, it is possible for the shared APs determined by the sharing AP do not connect with the STA which may be disturbed by the other shared AP(s), and the shared AP do not need to determine the proper STA to perform the data transmission. The ID information in the ID information list of APs may include at least one of the BSS ID information and the BSS color information of the AP. Moreover, the AP sensed by the STA or the candidate shared AP may refer to the signals sent from the AP can be detected by the STA or the candidate shared AP, or the signals sent from the AP can be detected by the STA or the candidate shared AP, and the strength of detected signal is greater than a certain threshold.

For example, the information on interferential APs in the response of the one of the plurality of candidate shared APs may include a BSS color list, which includes BSS color information of APs sensed by STAs connected with the one of the plurality of candidate shared APs. Moreover, the response of the one of the plurality of candidate shared APs may further include the BSS color information of the one of the plurality of candidate shared AP. The sharing AP may determine one or more shared APs based on the BSS color information of the plurality of candidate shared APs and BSS color lists of the plurality of candidate shared APs such that BSS color information of none of the shared APs is included in BSS color lists of other shared APs.

In the example shown in FIG. 2, the shared AP 120 and 130 may use all of the frequency and time resources in the TXOP shared by the sharing AP 110. In some cases, it is not necessary to use all of the frequency and time resources in the shared TXOP for the transmission of the shared APs 120 and 130. According to another example of the present disclosure, when the shared APs finish the data transmission with their STAs, the shared APs may send the signal to the sharing AP to return the TXOP. Thus, the sharing AP can assign the rest frequency and time resources in the shared TXOP to other shared AP(s).

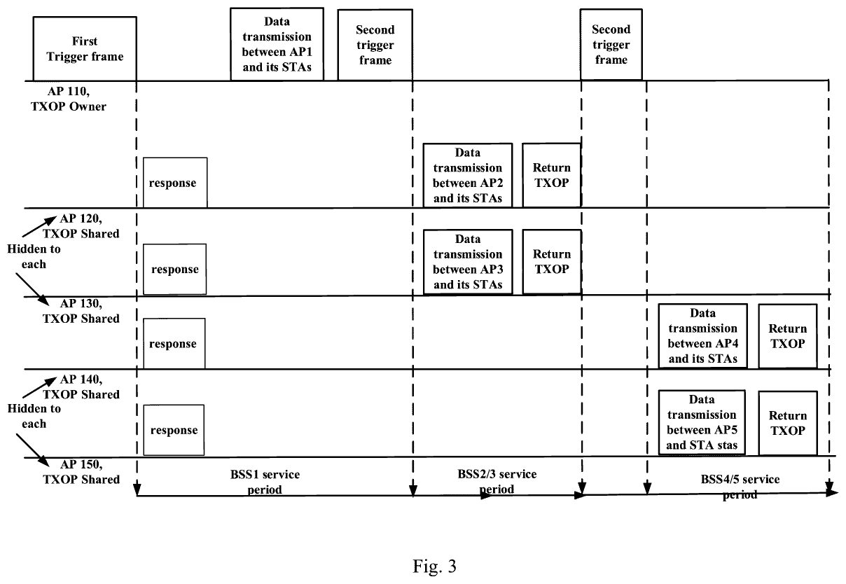

FIG. 3 is a diagram illustrating an example of the procedure for sharing the TXOP from a sharing AP to four shared APs, in accordance with the present disclosure. In the following, the procedure for sharing the TXOP shown in FIG. 3 will be described by taking the sharing AP and candidate shared APs shown in FIG. 1 as an example.

As shown in the FIG. 3, the AP 110 transmits a first trigger frame for announcing that the AP 110 has a TXOP to be shared. The AP 120, AP 130, AP 140 and AP 150 receive the first trigger frame. Moreover, each of the AP 120, AP 130, AP 140 and AP 150 transmits a response to the first trigger frame, wherein the response includes information on interferential APs of the corresponding AP.

In the example of FIG. 3, after receiving the responses from the AP 120, AP 130, AP 140 and AP 150, and the AP 110 determines one or more shared APs from the plurality of candidate shared APs based on the responses. Specifically, according to the information on interferential APs in the responses, the AP 110 determines the APs which are hidden to each other as the shared APs. For example, the AP 110 may determine the AP 120 and AP 130 as the shared APs which will share the same frequency and time resources in the shared TXOP. And the AP 110 transmits a second trigger frame to the shared APs (i.e. the AP 120 and AP 130), wherein the second trigger frame includes identity (ID) information of the shared APs. And then, the AP 120 can perform the data transmission to the STAs connected to the AP 120 by using the shared TXOP, and the AP 130 can perform the data transmission to the STAs connected to the AP 130 by using the same frequency and time resources in the shared TXOP.

As shown in FIG. 3, the shared APs 120 and 130 do not use all of the time period in the TXOP shared by the sharing AP 110. After finishing the data transmission with their STAs, the shared APs 120 and 130 send the signal to the sharing AP 110 to return the TXOP. According to the information on interferential APs in the responses to first trigger frame, the AP 110 may determine the APs other than the APs 120 and 130 as the new shared APs. For example, According to the information on interferential APs in the responses to first trigger frame, the APs 140 and 150 are hidden to each other as the shared APs. Thus, the AP 110 may determine the AP 140 and AP 150 as the new shared APs which will share the same frequency and time resources in the shared TXOP. And the AP 110 transmits anther second trigger frame to the shared APs (i.e. the AP 140 and AP 150), wherein the other second trigger frame includes identity (ID) information of the newly determined shared APs. And then, the AP 140 can perform the data transmission to the STAs connected to the AP 140 by using the shared TXOP, and the AP 150 can perform the data transmission to the STAs connected to the AP 150 by using the same frequency and time resources in the shared TXOP.

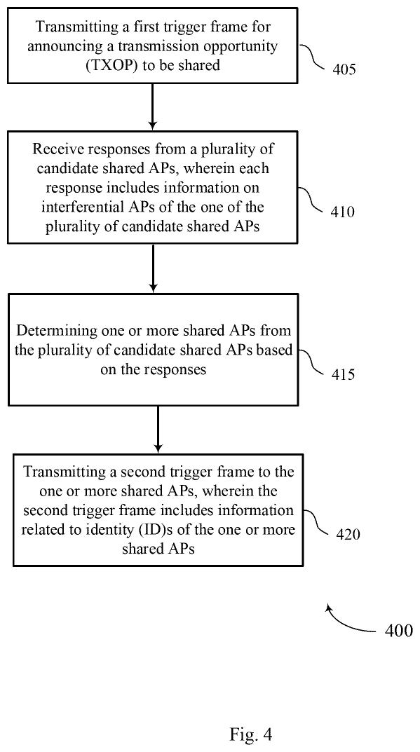

FIG. 4 shows a flowchart illustrating a method 400 for wireless communication at a sharing AP in accordance with one or more aspects of the present disclosure. The operations of method 400 may be implemented by a sharing AP or its components as described herein. For example, the operations of method 400 may be performed by the AP 110 as described with reference to FIGS. 1 through 3. In some examples, a sharing AP may execute a set of instructions to control the functional elements of the sharing AP to perform the functions described herein. Additionally or alternatively, a sharing AP may perform aspects of the functions described herein using special-purpose hardware.

At 405, the sharing AP may transmit a first trigger frame for announcing a transmission opportunity (TXOP) to be shared.

At 410, the sharing AP may receive responses from a plurality of candidate shared APs, wherein each response corresponds to one of the plurality of candidate shared APs, and includes information on interferential APs of the one of the plurality of candidate shared APs. At 415, the sharing AP may determine one or more shared APs from the plurality of candidate shared APs based on the responses. In one embodiment of the when more than one shared APs are determined, the more than one shared APs will share the same frequency and time resources of the TXOP.

For example, the information of on interferential APs of the one of the plurality of candidate shared APs includes a neighbour list, which includes ID information of APs sensed by the one of the plurality of candidate shared AP. At 415, the sharing AP may determine one or more shared APs based on neighbour lists of the plurality of candidate shared APs such that ID information of none of the shared APs is included in neighbor lists of other shared APs. The ID information of APs sensed by the one of the plurality of candidate shared APs may include the BSSID information of APs sensed by the one of the plurality of candidate shared AP.

For another example, the information on interferential APs of the one of the plurality of candidate shared APs includes a BSS color list which includes BSS color information of APs sensed by STAs connected with the one of the plurality of candidate shared APs. The response to the first trigger frame of one of the plurality of candidate shared APs may further determining BSS color information of the candidate shared AP. The method 400 performed by the sharing AP, may further include determining BSS color information of the candidate shared APs from the responses. At 415, the sharing AP may determine one or more shared APs based on the BSS color information of the plurality of candidate shared APs and BSS color lists of the plurality of candidate shared APs such that BSS color information of none of the shared APs is included in BSS color lists of other shared APs.

At 420, the sharing AP may transmit a second trigger frame which includes information related to identity (ID) s of the one or more shared APs. For example, the ID information of the one or more shared APs includes: BSSID information of one or more shared APs, BSS color information of one or more shared APs, or the combination thereof.

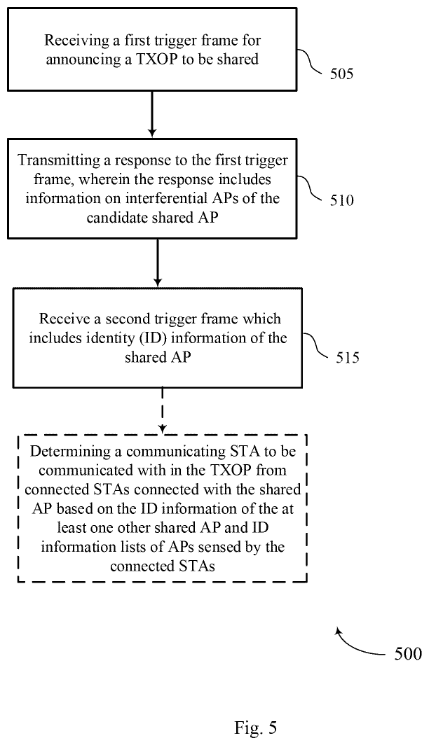

FIG. 5 shows a flowchart illustrating a method 500 for wireless communication at a shared AP in accordance with one or more aspects of the present disclosure. The operations of method 500 may be implemented by a shared AP or its components as described herein. For example, the operations of method 500 may be performed by the APs 120-130 as described with reference to FIGS. 1 through 3. In some examples, a shared AP may execute a set of instructions to control the functional elements of the shared AP to perform the functions described herein. Additionally or alternatively, a shared AP may perform aspects of the functions described herein using special-purpose hardware.

At 505, the shared AP may receive a first trigger frame for announcing a TXOP to be shared. At 510, the shared AP may transmit a response to the first trigger frame, wherein the response includes information on interferential APs of the shared AP. For example, the information on interferential APs of the shared AP may include a neighbour list, which includes ID information of the APs sensed by the shared AP. Alternatively, the information on interferential APs of the shared AP includes a BSS color list, which includes BSS color information of APs sensed by STAs connected with the shared AP. At 515, the shared AP may receive a second trigger frame which includes identity (ID) information of the shared AP.

According to one example of the present disclosure, The shared APs may determine the communicating STA to be communicated with based on the second trigger frame and an ID information list of APs sensed by the connected STA. The second trigger frame further includes ID information of the shared AP and at least one other shared AP. Additionally, when more than one shared APs are determined, the method 500 may further include the step of determining a communicating STA to be communicated with in the TXOP from connected STAs connected with the shared AP based on the ID information of the at least one other shared AP and ID information lists of APs sensed by the connected STAs, wherein the ID information of the at least one other shared AP is not included in the ID information list of APs sensed by the communicating STA.

For example, the ID information of shared AP and at least one other shared APs includes: the BSSID information of the shared AP and at least one other shared APs, the BSS color information of the shared AP and at least one other shared APs; or the combination thereof. Similarly, the ID information list of APs sensed by each of the connected STAs includes: BSSID information of APs sensed by each of the connected STAs, BSS color information of APs sensed by each of the connected STAs, or the combination thereof.

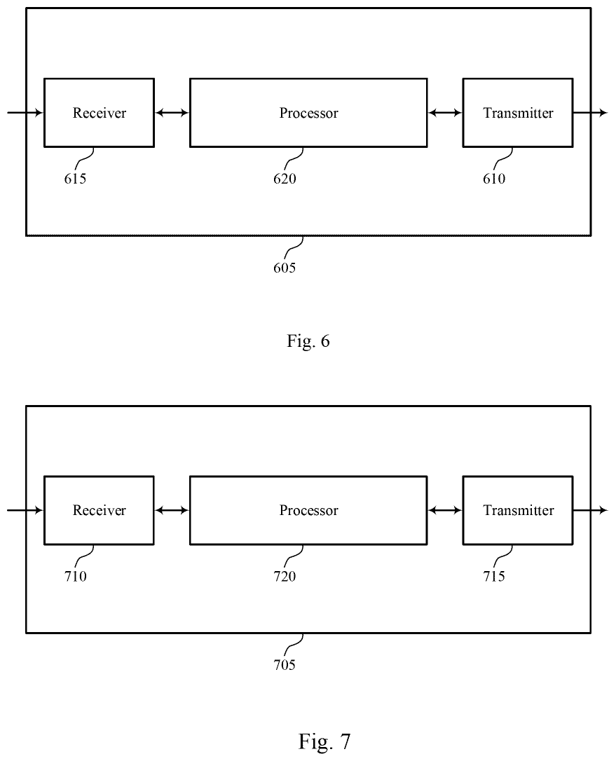

FIG. 6 shows a block diagram 600 of a sharing AP 605 that has TXOP to be shared in accordance with one or more aspects of the present disclosure. The sharing AP 605 may include a transmitter 610, a receiver 615, and a processor 620. Each of these components may be in communication with one another (e.g., via one or more buses).

The transmitter 610 may transmit signals generated by other components of the sharing AP 605. In some examples, the transmitter 610 may be collocated with a receiver 615 in a transceiver module. The transmitter 610 may utilize a single antenna or a set of antennas. The transmitter 610 may transmit a first trigger frame for announcing a transmission opportunity (TXOP) to be shared.

The receiver 615 may receive information such as packets, user data, or control information associated with various information channels (e.g., control channels, data channels, etc.). Information may be passed on to other components of the sharing AP 605. The receiver 615 may utilize a single antenna or a set of antennas. The receiver 615 may receive responses from a plurality of candidate shared APs, wherein each response corresponds to one of the plurality of candidate shared APs, and includes information on interferential APs of the one of the plurality of candidate shared APs.

The processor 620, or its sub-components, may be implemented in hardware (e.g., in communications management circuitry). The circuitry may comprise a CPU, a DSP, an ASIC, an FPGA, or other programmable logic device, discrete gate or transistor logic, discrete hardware components, or any combination thereof designed to perform the functions described in the present disclosure.

In another implementation, the processor 620, or its sub-components, may be implemented in hardware, code (e.g., communications management software or firmware) executed by a processor, or any combination thereof. If implemented in code executed by a processor, the functions of the base station communications manager 915, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

In some examples, the processor 620 may be configured to perform various operations (e.g., determining, transmitting) using or otherwise in cooperation with the receiver 615, the transmitter 610, or both.

The processor 620, or its sub-components, may be physically located at various positions, including being distributed such that portions of functions are implemented at different physical locations by one or more physical components. In some examples, the processor 620, or its sub-components, may be a separate and distinct component in accordance with various aspects of the present disclosure. In some examples, the processor 620, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The processor 620 may determine one or more shared APs from the plurality of candidate shared APs based on the responses. In one embodiment of the when more than one shared APs are determined, the more than one shared APs will share the same frequency and time resources of the TXOP.

For example, the information of on interferential APs of the one of the plurality of candidate shared APs includes a neighbour list, which includes ID information of APs sensed by the one of the plurality of candidate shared AP. The processor 620 may determine one or more shared APs based on neighbour lists of the plurality of candidate shared APs such that ID information of none of the shared APs is included in neighbor lists of other shared APs. The ID information of APs sensed by the one of the plurality of candidate shared APs may include the BSSID information of APs sensed by the one of the plurality of candidate shared AP.

For another example, the information on interferential APs of the one of the plurality of candidate shared APs includes a BSS color list which includes BSS color information of APs sensed by STAs connected with the one of the plurality of candidate shared APs. The response to the first trigger frame of one of the plurality of candidate shared APs may further determining BSS color information of the candidate shared AP. The processor 620 may include determining BSS color information of the candidate shared APs from the responses. The processor 620 may determine one or more shared APs based on the BSS color information of the plurality of candidate shared APs and BSS color lists of the plurality of candidate shared APs such that BSS color information of none of the shared APs is included in BSS color lists of other shared APs.

Moreover, the transmitter 610 may transmit a second trigger frame which includes information related to identity (ID) s of the one or more shared APs. For example, the ID information of the one or more shared APs includes: BSSID information of one or more shared APs, BSS color information of one or more shared APs, or the combination thereof.

FIG. 7 shows a block diagram 700 of a shared AP 705 in accordance with one or more aspects of the present disclosure. The shared AP 705 may include a receiver 710, a transmitter 715, and a processor 720. Each of these components may be in communication with one another (e.g., via one or more buses).

The receiver 710 may receive information such as packets, user data, or control information associated with various information channels (e.g., control channels, data channels, etc.). Information may be passed on to other components of the shared AP 705. The receiver 710 may utilize a single antenna or a set of antennas. The receiver 710 may receive a first trigger frame for announcing a TXOP to be shared.

The transmitter 715 may transmits signals generated by other components of the shared AP 705. In some examples, the transmitter 715 may be collocated with a receiver 710 in a transceiver module. The transmitter 715 may utilize a single antenna or a set of antennas. The transmitter 715 may transmit a response to the first trigger frame, wherein the response includes information on interferential APs of the shared AP. For example, the information on interferential APs of the shared AP may include a neighbour list, which includes ID information of neighbour APs sensed by the shared AP. Alternatively, the information on interferential APs of the shared AP includes a BSS color list, which includes BSS color information of APs sensed by STAs connected with the shared AP. Moreover, the receiver 710 may receive a second trigger frame which includes identity (ID) information of the shared AP.

According to one example of the present disclosure, The shared APs may determine the communicating STA to be communicated with based on the second trigger frame and an ID information list of APs sensed by the connected STA. The second trigger frame further includes ID information of the shared AP and at least one other shared AP. Additionally, when more than one shared APs are determined, the processor 720 may determine a communicating STA to be communicated with in the TXOP from connected STAs connected with the shared AP based on the ID information of the at least one other shared AP and ID information lists of APs sensed by the connected STAs, wherein the ID information of the at least one other shared AP is not included in the ID information list of APs sensed by the communicating STA.

For example, the ID information of shared AP and at least one other shared APs includes: the BSSID information of one or more shared APs, the BSS color information of shared AP and at least one others; or the combination thereof. Similarly, the ID information list of APs sensed by each of the connected STAs includes: BSSID information of APs sensed by each of the connected STA, BSS color information of APs sensed by each of the connected STA, or the combination thereof.

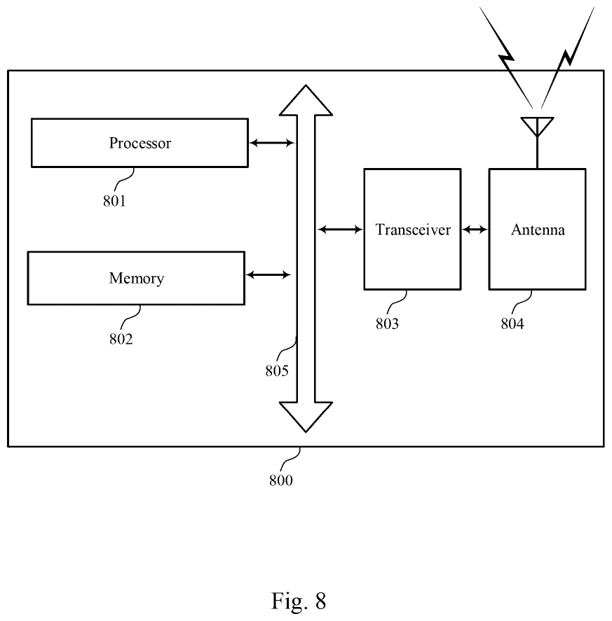

FIG. 8 is a schematic block diagram of an AP 800 according to one embodiment of the present disclosure. It should be noted that AP 800 depicted in FIG. 8 may correspond to sharing AP or the shared AP as described above and may be used to perform the operations of sharing TOXP as described in the above with respect to method 400 and method 500.

As shown in FIG. 8, AP 800 may comprise processor 801, memory 802, a transceiver 803, an antenna 804. These components may be in electronic communication via one or more buses (e.g., bus 805). Processor 801 is communicatively coupled with the memory and configured to perform steps in method 400 or method 500 discussed above.

Examples of processor 801 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

Processor 801 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 802.

Memory 802 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software (e.g. code and/or instructions) that may be accessed and read by a computer. Memory 802 may reside in processor 801, external to processor 801, or distributed across multiple entities including processor 801. Memory 802 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

The transceiver 803 may communicate bi-directionally, via one or more antennas, wired, or wireless links as described herein. For example, the transceiver 803 may represent a wireless transceiver and may communicate bi-directionally with another wireless transceiver. The transceiver 803 may also include a modem to modulate the packets and provide the modulated packets to the antennas for transmission, and to demodulate packets received from the antennas. In some cases, the wireless device may include a single antenna 804. However, in some cases the device may have more than one antenna 804, which may be capable of concurrently transmitting or receiving multiple wireless transmissions.

In addition, according to another embodiment of the present disclosure, a computer program product for controlling the bandwidth of a channel including a plurality of subchannels is disclosed. As an example, the computer program product comprises a non-transitory computer readable storage medium having program instructions embodied therewith, and the program instructions are executable by a processor. When executed, the program instructions cause the processor to perform one or more of the procedures above described, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

An expression such as “according to”, “based on”, “depend on”, and so on as used in the disclosure does not mean “according only to”, “based only on”, or “dependent only on”, unless it is explicitly otherwise stated. In other words, such expression generally means “according at least to”, “based at least on”, or “depend at least on” in the disclosure.

Any reference in the disclosure to an element using the designation “first”, “second” and so forth is not intended to comprehensively limit the number or order of such elements. These expressions may be used in the disclosure as a convenient method for distinguishing two or more units. Thus, a reference to a first unit and a second unit does not imply that only two units may be employed or that the first unit must precede the second unit in some form.

The term “determining” used in the disclosure may include various operations. For example, regarding “determining”, calculating, computing, processing, deriving, investigating, looking up (e.g., looking up in tables, databases, or other data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth may also be regarded as “determining”. That is, regarding “determining”, several actions may be regarded as “determining”.

The terms such as “connected”, “coupled” or any of their variants used in the disclosure refer to any connection or combination, direct or indirect, between two or more units, which may include the following situations: between two units that are “connected” or “coupled” with each other, there are one or more intermediate units. The coupling or connection between the units may be physical or logical or may also be a combination of the two. As used in the disclosure, two units may be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

It should be noted that the above description is only some embodiments of the present disclosure and an illustration of the applied technical principles. It should be understood by those skilled in the art that the present disclosure scope involved in the present disclosure is not limited to the technical solutions resulting from specific combinations of the above technical features, but also encompasses other technical solutions resulting from any combination of the above technical features or their equivalents without departing from the above disclosed concept, for example, the technical solutions formed by replacing between the above features and the technical features with similar functions disclosed in the present disclosure (but not limited hereto).

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. A sharing access point (AP), comprising:
a transmitter configured to transmit a first trigger frame for announcing a transmission opportunity (TXOP) to be shared;
a receiver configured to receive responses from a plurality of candidate shared APs, wherein each response corresponds to one of the plurality of candidate shared APs, and includes information on interferential APs of the one of the plurality of candidate shared APs; and
a processor configured to determine one or more shared APs from the plurality of candidate shared APs based on the responses,
wherein the transmitter is further configured to transmit a second trigger frame which includes identity (ID) information of the one or more shared APs.

2. The sharing AP of claim 1, wherein
the information on interferential APs of the one of the plurality of candidate shared APs includes a neighbour list which includes ID information of APs sensed by the one of the plurality of candidate shared AP; and
the determining one or more shared APs from the plurality of candidate shared APs based on the responses comprises:
determining one or more shared APs based on neighbour lists of the plurality of candidate shared APs such that ID information of none of the shared APs is included in neighbor lists of other shared APs.

3. The sharing AP of claim 2, wherein
the ID information of APs sensed by the one of the plurality of candidate shared APs includes BSSID information of APs sensed by the one of the plurality of candidate shared AP.
the information on interferential APs of the one of the plurality of candidate shared APs further includes BSS color information of the shared AP.

4. The sharing AP of claim 3, wherein
the ID information of the one or more shared APs includes BSSID information of the one or more shared APs.

5. The sharing AP of claim 4, wherein
each response corresponding to one of the plurality of candidate shared APs further includes BSS color information of the one of the plurality of candidate shared AP; and
the ID information of the one or more shared APs further includes BSS color information of the shared APs.

6. The sharing AP of claim 1, wherein
the information on interferential APs of the one of the plurality of candidate shared APs includes a BSS color list which includes BSS color information of APs sensed by one or more stations (STAs) connected with the one of the plurality of candidate shared APs and BSS color information of APs sensed by the one of the plurality of candidate shared APs;
each response corresponding to one of the plurality of candidate shared APs further includes BSS color information of the one of the plurality of candidate shared AP; and
the determining one or more shared APs from the plurality of candidate shared APs based on the responses:
determining one or more shared APs based on the BSS color information of the plurality of candidate shared APs and BSS color lists of the plurality of candidate shared APs such that BSS color information of none of the shared APs is included in BSS color lists of other shared APs.

7. The sharing AP of claim 1, wherein
when more than one shared APs are determined, the more than one shared APs will share the same frequency and time resources of the TXOP.

8. A shared access point (AP), comprising:
a receiver configured to receive a first trigger frame for announcing a transmission opportunity (TXOP) to be shared; and
a transmitter configured to transmit a response to the first trigger frame, wherein the response includes information on interferential APs of the shared AP,
wherein the receiver is further configured to receive a second trigger frame which includes identity (ID) information of the shared AP.

9. The shared AP of claim 8, wherein
the information on interferential APs of the shared AP includes a neighbour list which includes ID information of neighbour APs sensed by the shared AP.

10. The shared AP of claim 8, wherein
the response further includes BSS color information of the shared AP.

11. The shared AP of claim 8, wherein
the second trigger frame further includes ID information of the shared AP and at least one other shared AP; and
the shared AP further comprises a processor configured to determine a communicating STA to be communicated with in the TXOP from connected STAs connected with the shared AP based on the ID information of the at least one other shared AP and ID information lists of APs sensed by the connected STAs, wherein the ID information of the at least one other shared AP is not included in the ID information list of APs sensed by the communicating STA.

12. The shared AP of claim 11, wherein the ID information of the shared AP and at least one other shared APs includes:
BSSID information of the shared AP and at least one other shared APs;
BSS color information of the shared AP and at least one other shared APs; or
the combination thereof.

13. The shared AP of claim 11, wherein the ID information lists of APs sensed by each of the connected STAs includes:
BSSID information of APs sensed by each of the connected STAs;
BSS color information of APs sensed by each of the connected STAs; or
the combination thereof.

14. The shared AP of claim 8, wherein
the information on interferential APs of the candidate shared AP includes a BSS color list which includes BSS color information of APs sensed by connected STAs connected with the shared AP and BSS color information of APs sensed by the shared APs.

15. A method for wireless communication at a sharing access point (AP), comprising:
transmitting a first trigger frame for announcing a transmission opportunity (TXOP) to be shared;
receiving responses from a plurality of candidate shared APs, wherein each response corresponds to one of the plurality of candidate shared APs, and includes information on interferential APs of the one of the plurality of candidate shared APs;
determining one or more shared APs from the plurality of candidate shared APs based on the responses; and
transmitting a second trigger frame which includes information related to identity (ID) s of the one or more shared APs.

16. The method of claim 15, wherein
the information of on interferential APs of the one of the plurality of candidate shared APs includes a neighbour list, which includes ID information of APs sensed by the one of the plurality of candidate shared AP; and
the determining one or more shared APs from the plurality of candidate shared APs based on the responses comprises:
determining one or more shared APs based on neighbour lists of the plurality of candidate shared APs such that ID information of none of the shared APs is included in neighbor lists of other shared APs.

17. The method of claim 16, wherein
the ID information of APs sensed by the one of the plurality of candidate shared APs includes BSSID information of APs sensed by the one of the plurality of candidate shared AP.

18. The method of claim 17, wherein
the ID information the one or more shared APs includes the BSSID information of the one or more shared APs.

19. The method of claim 18, wherein
each response corresponding to one of the plurality of candidate shared APs further includes BSS color information of the one of the plurality of candidate shared AP; and
the ID information of the one or more shared APs further includes BSS color information of the shared APs.

20. The method of claim 15, wherein
the information on interferential APs of the one of the plurality of candidate shared APs includes a BSS color list which includes BSS color information of APs sensed by one or more stations (STAs) connected with the one of the plurality of candidate shared APs and BSS color information of APs sensed by the one of the plurality of candidate shared APs;
each response corresponding to one of the plurality of candidate shared APs further includes BSS color information of the one of the plurality of candidate shared AP; and
the determining one or more shared APs from the plurality of candidate shared APs based on the responses:
determining one or more shared APs based on the BSS color information of the plurality of candidate shared APs and BSS color lists of the plurality of candidate shared APs such that BSS color information of none of the shared APs is included in BSS color lists of other shared APs.
